(19) United States
(12) Patent Application Publication
(10) Pub. No.: US 2024/0097764 A1
(43) Pub. Date: Mar. 21, 2024

(54) CSI FEEDBACK IN CELLULAR SYSTEMS

(71) Applicant: Samsung Electronics Co., Ltd., Suwon-si (KR)

(72) Inventor: Jeongho Jeon, San Jose, CA (US)

(21) Appl. No.: 18/460,476

(22) Filed: Sep. 1, 2023

Related U.S. Application Data
(60) Provisional application No. 63/408,807, filed on Sep. 21, 2022.

(51) Int. Cl. H04B 7/06; H04B 17/391; H04W 24/02

(52) U.S. Cl. CPC H04B 7/0626; H04B 17/3913; H04W 24/02

(57) ABSTRACT

Method and apparatuses for channel state information (CSI) feedback in cellular systems. A method for operating a user equipment (UE) to report CSI includes transmitting first information related to a capability of the UE to support machine learning (ML) based CSI reporting and second information related to a selection of a ML model for CSI reporting. The method further includes receiving third information related to configuring a first ML model for determining the CSI, fourth information related to processing a ML model output, fifth information related to reception of CSI reference signals (CSI-RS s) on a cell, and the CSI-RSs based on the fifth information. The method further includes determining, based on the third and fourth information and the reception of the CSI-RSs, a CSI report using the first ML model and transmitting a channel with the CSI report.

### CROSS-REFERENCE TO RELATED AND CLAIM PRIORITY

The present application claims priority under 35 U.S.C. § 119(e) to U.S. Provisional Patent Application No. 63/408,807 filed on Sep. 21, 2022, which is hereby incorporated by reference in its entirety.

### TECHNICAL FIELD

The present disclosure relates generally to wireless communication systems and, more specifically, the present disclosure relates to methods and apparatuses for channel state information (CSI) feedback in cellular systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to methods and apparatuses for CSI feedback in cellular systems.

In one embodiment, a method for operating a user equipment (UE) to report channel state information (CSI) is provided. The method includes transmitting first information related to a capability of the UE to support machine learning (ML) based CSI reporting and second information related to a selection of a ML model for CSI reporting. The method further includes receiving third information related to configuring a first ML model for determining the CSI, fourth information related to processing a ML model output, fifth information related to reception of CSI reference signals (CSI-RS s) on a cell, and the CSI-RSs based on the fifth information. The method further includes determining, based on the third and fourth information and the reception of the CSI-RSs, a CSI report using the first ML model and transmitting a channel with the CSI report.

In another embodiment, a base station (BS) is provided. The BS includes a transceiver configured to receive first information related to a capability of a UE to support ML based CSI reporting and receive second information related to a selection of a ML model for CSI reporting. The transceiver is further configured to transmit third information related to configuring a first ML model for determining the CSI, transmit fourth information related to processing a ML model output, transmit fifth information related to transmission of CSI-RS s on a cell, and transmit the CSI-RSs based on the fifth information. The transceiver is further configured to receive a channel with a CSI report based on the first ML model and the CSI-RS s.

In yet another embodiment, a UE is provided. The UE includes a transceiver configured to transmit first information related to a capability of the UE to support ML based CSI reporting and transmit second information related to a selection of a ML model for CSI reporting. The transceiver is further configured to receive third information related to configuring a first ML model for determining the CSI, receive fourth information related to processing a ML model output, receive fifth information related to reception of CSI-RS s on a cell, and receive the CSI-RS s based on the fifth information. The UE further includes a processor operably coupled to the transceiver. The processor is configured to determine, based on the third and fourth information and the reception of the CSI-RS s, a CSI report using the first ML model. The transceiver is further configured to transmit a channel with the CSI report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5 illustrates an example of a transmitter structure for beamforming according to embodiments of the present disclosure;

FIG. 6 illustrates an example of a diagram showing artificial intelligence (AI)/machine learning (ML)-based CSI feedback according to embodiments of the present disclosure;

FIG. 7 illustrates a procedure of an example AI/ML-based feedback management model according to embodiments of the present disclosure;

FIG. 8 illustrates a flowchart of an example UE procedure for lifecycle management of AL/ML-based CSI feedback according to embodiments of the present disclosure; and

FIG. 9 illustrates an example method performed by a UE in a wireless communication system according to embodiments of the present disclosure.

### DETAILED DESCRIPTION

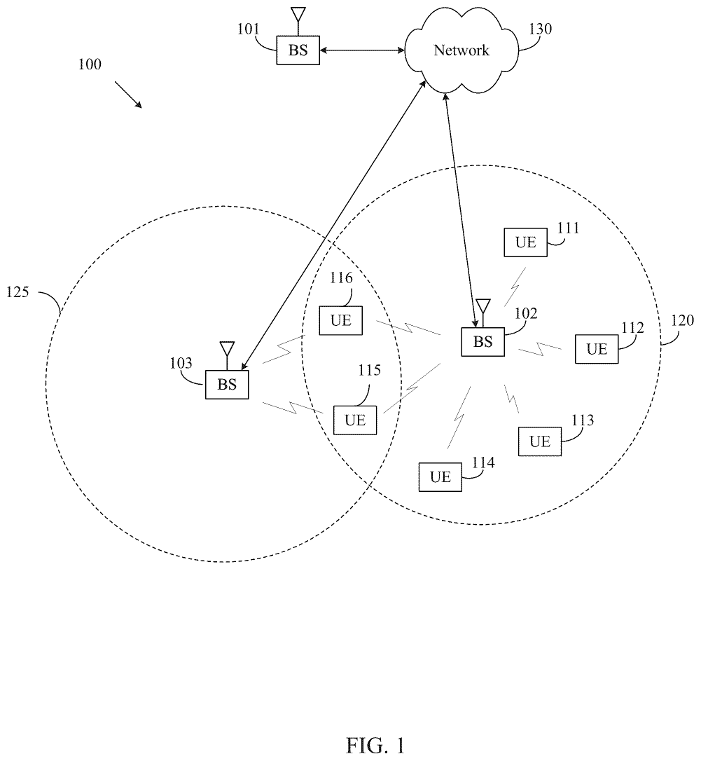

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.2.0, “NR; Physical channels and modulation;” [2] 3GPP TS 38.212 v17.2.0, “NR; Multiplexing and Channel coding;” [3] 3GPP TS 38.213 v17.2.0, “NR; Physical Layer Procedures for Control;” [4] 3GPP TS 38.214 v17.2.0, “NR; Physical Layer Procedures for Data;” [5] 3GPP TS 38.215 v17.1.0, “NR; Physical layer measurements;” [6] 3GPP TS 38.331 v17.1.0, “NR; Radio Resource Control (RRC) protocol specification;” [7] 3GPP TS 38.321 v17.1.0, “NR; Medium Access Control (MAC) protocol specification;” [8] 3GPP TS 38.133 v17.6.0, “NR; Requirements for support of radio resource management.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3 rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing intelligent CSI feedback in cellular systems. In certain embodiments, one or more of the BSs 101-103 include circuitry, programing, or a combination thereof to support intelligent CSI feedback in cellular systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

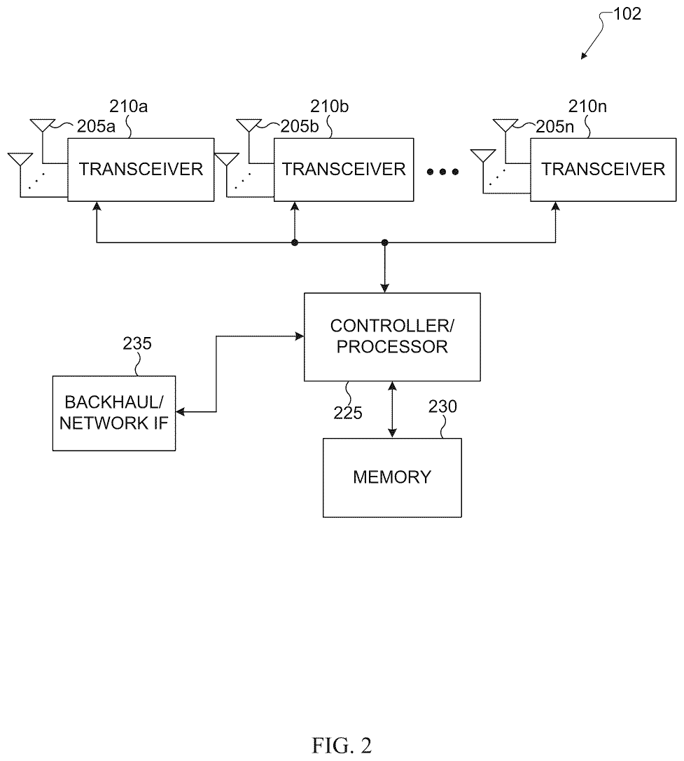

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNB s come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting intelligent CSI feedback in cellular systems. Any of a wide variety of other functions could be supported in the gNB 102 by the controller/processor 225.

The controller/processor 225 is also capable of executing programs and other processes resident in the memory 230, such as processes to support intelligent CSI feedback in cellular systems in accordance with various embodiments of the present disclosure. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

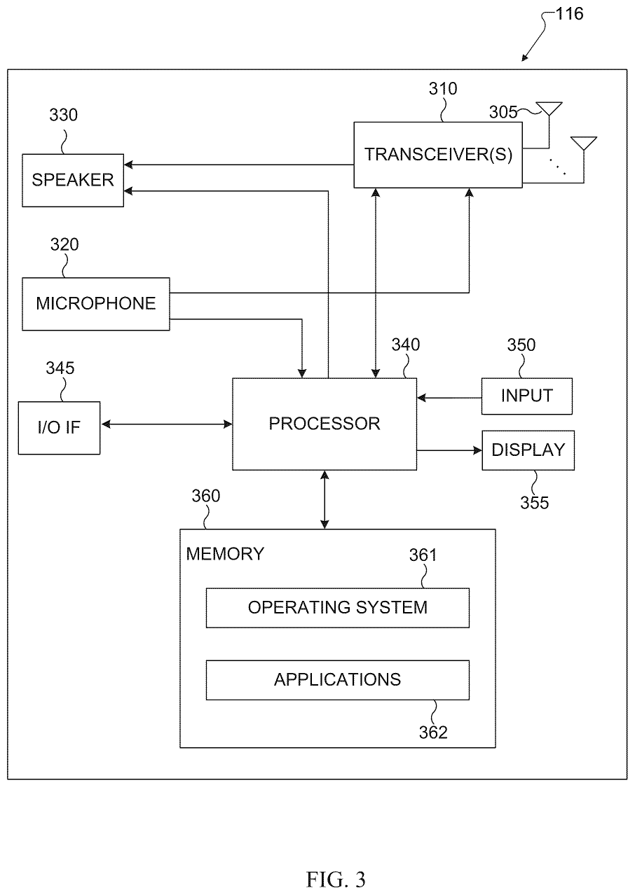

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to preform intelligent CSI feedback in cellular systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

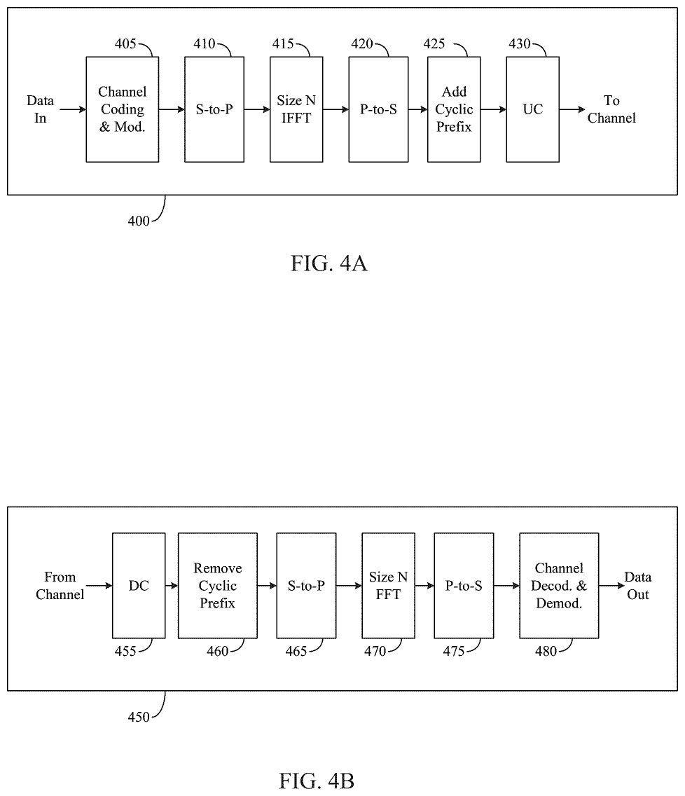

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 450 is configured to support intelligent CSI feedback in cellular systems as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

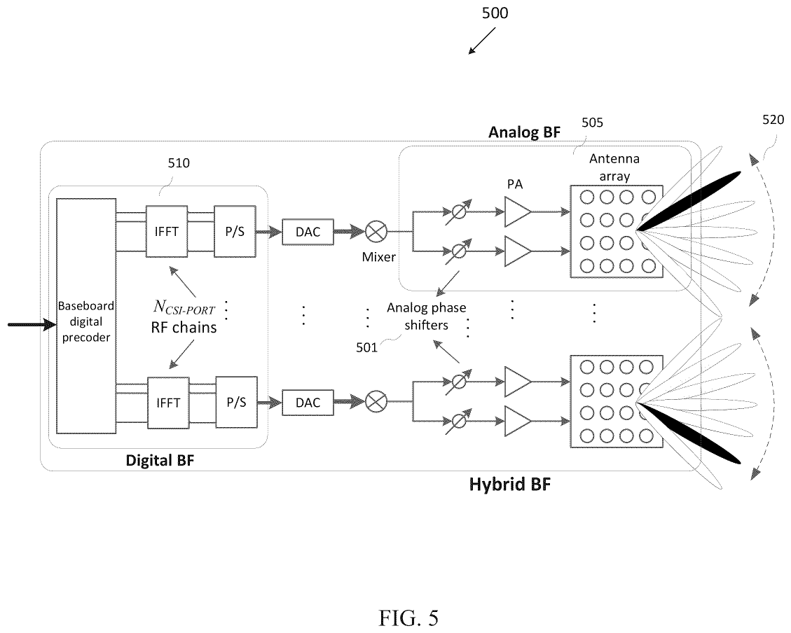

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosure herein that changes in the embodiments and examples shown may be made without departing from the scope of the present disclosure. The transmitter structure 500 for beamforming is for illustration only and other embodiments can be used without departing from the scope of the present disclosure.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

In the following, subframe (SF) refers to a transmission time unit for the LTE radio access technology (RAT) and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments examine a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the present disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

The multiple input multiple output (MIMO) technologies have been playing an integral role in boosting system throughput both in NR and LTE and such a role will be continued and further expanded in the future generation wireless technologies.

An antenna port is defined such that the channel over which a symbol on the antenna port is conveyed can be inferred from the channel over which another symbol on the same antenna port is conveyed. There is not necessarily one to one correspondence between an antenna port and an antenna element, and a plurality of antenna elements can be mapped onto one antenna port.

To enable digital precoding, efficient design of CSI-RS is a vital factor. For this reason, three types of CSI reporting mechanism corresponding to three types of CSI-RS measurement behavior are supported in Rel. 13 LTE: 1) ‘CLASS A’ CSI reporting which corresponds to non-precoded CSI-RS, 2) ‘CLASS B’ reporting with K=1 CSI-RS resource which corresponds to UE-specific beamformed CSI-RS, 3) ‘CLASS B’ reporting with K>1 CSI-RS resources which corresponds to cell-specific beamformed CSI-RS. For non-precoded (NP) CSI-RS, a cell-specific one-to-one mapping between CSI-RS port and TXRU is utilized. Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource (consisting of multiple ports). Here, (at least at a given time/frequency) CSI-RS ports have narrow beam widths and hence not cell-wide coverage, and (at least from the eNB perspective) at least some CSI-RS port-resource combinations have different beam directions. The basic principle remains the same in NR.

In scenarios where DL long-term channel statistics can be measured through UL signals at a serving gNB, UE-specific beamformed CSI-RS can be readily used. This is typically feasible when UL-DL duplex distance is sufficiently small. When this condition does not hold, however, some UE feedback is essential for the gNB 102 to obtain an estimate of DL long-term channel statistics (or any of its representation thereof). To facilitate such a procedure, a first beamformed CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

One of the key components of a MIMO transmission scheme is the accurate CSI acquisition at the gNB 102 (or TRP). For multiple user (MU)-MIMO, in particular, the availability of accurate CSI is essential in order to guarantee high MU performance. For time division duplex (TDD) systems, the CSI can be acquired using the SRS transmission relying on the channel reciprocity. For frequency division duplexing (FDD) systems, on the other hand, it can be acquired using the CSI-RS transmission from gNB, CSI acquisition, and feedback from UE. In LTE up to Rel. 13, for FDD systems, the CSI feedback framework is ‘implicit’ in the form of channel quality information (CQI)/precoding matrix indicator (PMI)/rank indicator (RI) (and coverage and rate information (CRI) in Rel. 13) derived from a codebook assuming SU transmission from eNB. Because of the inherent SU assumption while deriving CSI, this implicit CSI feedback is inadequate for MU transmission. On the other hand, NR system has been designed to be more MU-centric from its first release with high resolution Type-II codebook in addition to low resolution Type-I codebook.

In the present network, the applications of AI/ML-based methods have been mostly limited to network layers. A virtualized RAN with open interfaces and network intelligence with entities such as Non-Real-Time (RT) RAN Intelligence Controller (MC) and near-RT MC has been defined by the O-RAN Alliance. The Non-RT MC is a logical function that enables non-real-time control and optimization of RAN elements and resources, which governs the overall AI/ML workflow for an O-RAN network, including model training, inference, and updates. The Near-RT MC is a logical function that enables near-real-time control and optimization of RAN elements and resources via fine-grained data collection and actions over the RAN interface. On the other hand, the 3GPP has defined Network Data Analytics Function (NWDAF) for network slice management in Rel-15 and it has been further enhanced in Rel-16 and Rel-17. The 3GPP also defined the functional framework for RAN intelligence enabled by data collection.

It is expected that AI/ML methods will be applied for various cellular system air interface designs including CSI compression/recovery, future CSI prediction, learning-based channel estimation, channel coding, and modulation, just to name a few. Typical physical layer algorithms have been derived based on the simplifying assumptions such as linear system model, Additive White Gaussian Noise (AWGN) channel, etc. By exploiting AI/ML methods, an optimal algorithm can be developed for more practical system assumptions such as nonlinearity, fading channels, etc.

It is also expected that, depending on the use cases, the improvements can be not only on the system performance such as throughput, spectral efficiency, and latency but also on the complexity, reliability, and overhead, etc. Moreover, the optimization can be done not only in the piecewise manner for a given transmitter/receiver processing function but also in the end-to-end manner including the entire transmitter/receiver processing chains. Therefore, it is expected that the scope of AI/ML application in the cellular system will be continuously expanded.

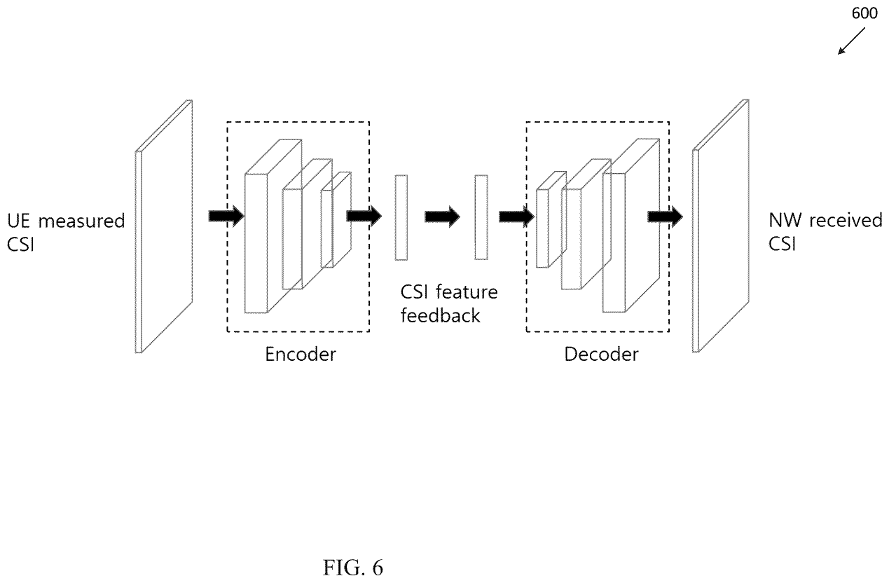

FIG. 6 illustrates an example of a diagram 600 showing AWL-based CSI feedback according to embodiments of the present disclosure. For example, the AWL-based CSI feedback shown in diagram 600 may performed between the gNB 102 and/or network 130 and the UE 116 in the wireless network 100 of FIG. 1. This example is for illustration only and other embodiments can be used without departing from the scope of the present disclosure.

A UE derives CSI from DL CSI-RS measurement, compresses the CSI using AI/ML-based CSI encoder, and send the output of the CSI encoder as a CSI report to the network 130. The network 130 receives the CSI report from the UE 116, uses it as an input to the AI/ML-based CSI decoder, and reconstructs the CSI from the UE 116. AWL-based CSI feedback can be contemplated as one candidate for next generation CSI acquisition method that can replace the current method based on the DFT basis selection and the expression of precoding matrix via a linear combination of selected basis set such as Type-II codebook in NR.

Embodiments of the present disclosure recognize that the choice of a proper AI/ML model can be tailored to UE's AI/ML processing capability, environment, and situations. Therefore, there is a need to define a new set of signaling to indicate UE's AI/ML capability related to CSI feedback, to transmit assistance information on UE's environment and/or situation to assist network's decision making, and to configure an AI/ML model for CSI feedback to the UE 116.

The effectiveness of currently employed AWL-based CSI feedback model may be subject to UE's environmental or situational changes. Therefore, there is another need to define a new set of signaling to support performance monitoring of an AI/ML model and reporting.

In cases when the currently employed AWL-based CSI feedback model is regarded ineffective, the current AI/ML model needs to be updated or replaced with another AI/ML model or with a non-AI/ML based method. Therefore, there is another need to define a new set of signaling to support AI/ML model switch, update, retraining, or fallback to a default method.

Embodiments of the present disclosure relate to a communication system. The present disclosure relates to defining functionalities and procedures to support AI/ML-based CSI feedback.

Embodiments of the present disclosure further relate to indicating a UE capability information regarding AI/ML-based CSI feedback.

Embodiments of the present disclosure also relate to configuring AI/ML model for CSI feedback to UE.

Embodiments of the present disclosure further relate to AWL-based CSI feedback model performance monitoring and reporting.

Embodiments of the present disclosure also relate to performing AWL-based CSI feedback model switch, update, retraining, or fallback to a default feedback method.

Embodiments of the present disclosure describe enabling lifecycle management of AWL-based methods for cellular system air interface, such as, for example, for supporting AWL-based CSI feedback, which are summarized and fully elaborated further herein.
Method and apparatus for indicating UE capabilities related to AWL-based CSI feedback including supported models, neural network types, complexity, and the support of model transfer, switch, update, training, and fallback.
Method and apparatus for indicating an AWL model for CSI feedback to UE, e.g., via model ID, model transfer, or model description including neural network structure, parameter values, and feedback format.
Method and apparatus for performing AWL-based CSI feedback model monitoring including indicating performance index to monitor, triggering events to send a report and/or transmission of any assistance information to the network.
Method and apparatus for switching, updating, retraining AWL model for CSI feedback and/or indicating to fallback to a default feedback mode.

A detailed description of systems and methods consistent with embodiments of the present disclosure is provided herein. While several embodiments are described, the present disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all details. Moreover, for the purpose of clarity, certain technical material that is known in the related art has not been described in detail in order to avoid unnecessarily obscuring the present disclosure.

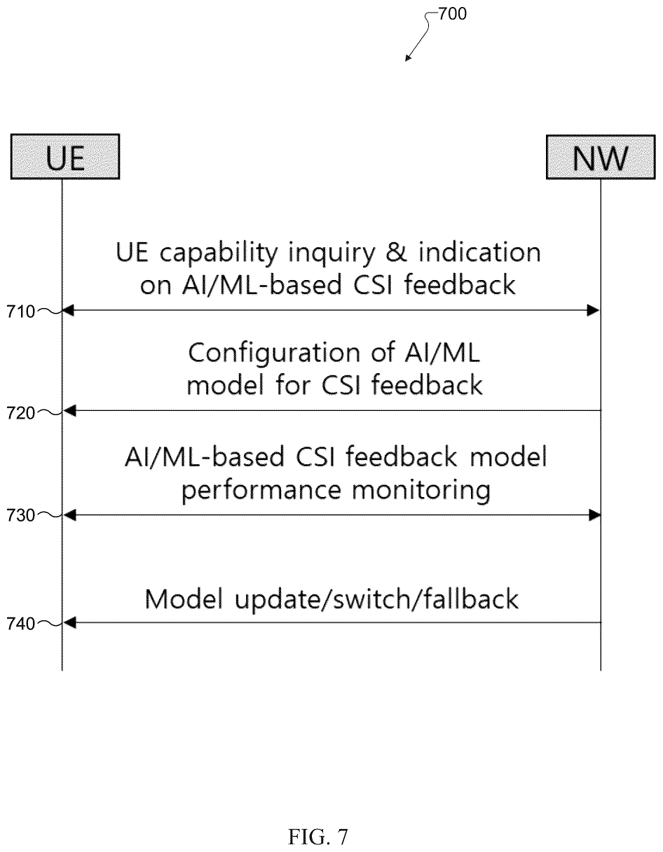

FIG. 7 illustrates a procedure 700 of an example AWL-based feedback management model according to embodiments of the present disclosure. For example, procedure 700 can be performed by the UE 116 and the gNB 102 and/or network 130 in the wireless network 100 of FIG. 1. This example is for illustration only and other embodiments can be used without departing from the scope of the present disclosure.

In 710, a network requests UE capability related to AWL-based CSI feedback and the UE provides UE capability related to AWL-based CSI feedback. In 720, the network then provides AI/ML model configuration for CSI feedback and the UE receives AI/ML model configuration for CSI feedback. In 730, the network and the UE then perform model performance monitoring for AWL-based CSI feedback. In 740, the network then provides AWL-based CSI feedback model update, switch, and/or fallback and the UE receives AI/ML-based CSI feedback model update, switch, and/or fallback.

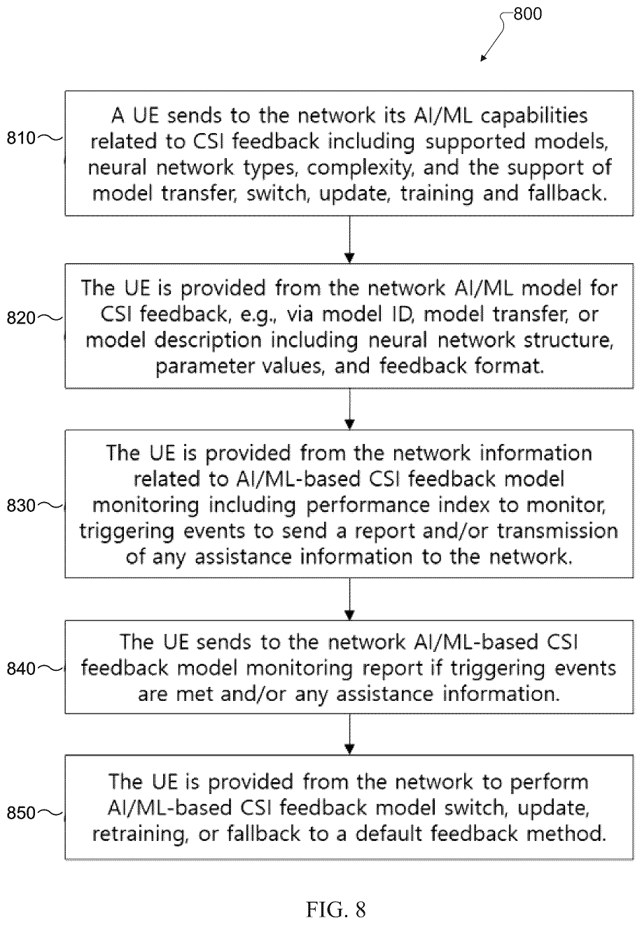

FIG. 8 illustrates a flowchart of an example UE procedure 800 for lifecycle management of AL/ML-based CSI feedback according to embodiments of the present disclosure. For example, procedure 800 can be performed by any of the UEs 111-116 of FIG. 1. This example is for illustration only and other embodiments can be used without departing from the scope of the present disclosure.

The procedure starts with 810, a UE sends to the network 130 its AI/ML capabilities related to CSI feedback including supported models, neural network types, complexity, and the support of model transfer, switch, update, training, and fallback. In 820, the UE 116 is then provided, from the network 130, an AI/ML model for CSI feedback, e.g., via model ID, model transfer, or model description including neural network structure, parameter values, and feedback format. In 830, the UE 116 is then provided, from the network 130, information related to AI/ML-based CSI feedback model monitoring including performance index to monitor, triggering events to send a report and/or transmission of any assistance information to the network 130. In 840, the UE 116 then sends to the network 130 an AI/ML-based CSI feedback model monitoring report if triggering events are met and/or any assistance information. In 850, the UE 116 is then provided, from the network 130, to perform an AI/ML-based CSI feedback model switch, update, retraining, or fallback to a default feedback method.

A UE sends to a serving cell UE capability information regarding its AI/ML-based CSI feedback capability, e.g., during initial registration process or handover in response to UECapabilityEnquiry message from the network 130.

In one embodiment, the UE 116 capability information includes an indication on whether the UE 116 supports AWL-based CSI feedback or not. For example, it can be Boolean indication in the capability signaling.

In another embodiment, the UE 116 capability information includes an indication on the list of supported AI/ML models for CSI feedback. For example, the UE 116 may have multiple site-specifically trained models. As an example, it can be a sequence of Boolean indication for the support of CSI feedback models trained for different channel environments including but not limited to urban macrocells (Uma)/urban microcells (Umi)/indoor hotspot (InH)/rural, line-of-sight (LOS)/non-line-of-sight (NLOS), a set of different UE speeds, etc.

In another embodiment, the UE 116 capability information includes an indication on whether the UE 116 supports one-sided, two-sided, or both one-sided and two-sided AI/ML models for CSI feedback.

In another embodiment, the UE 116 capability information includes an indication on the types of supported training modes. For example, it can indicate whether the UE 116 supports online/offline training, separate/joint training, and/or transferred learning. As illustrated in FIG. 6, the AI/ML-based CSI feedback may be comprised of a CSI encoder at the UE 116 and a CSI decoder at the network 130. The CSI encoder at the UE 116 may be separately trained from the CSI decoder at the network 130 with no knowledge on the CSI decoder and the training dataset at the network 130 or with limited knowledge such as the assumption on the reference CSI decoder model, although it may not be the actual model used at the network 130. The CSI encoder at the UE 116 may be jointly trained with the CSI decoder at the network 130 either by a single node/entity, e.g., UE or network, or by both UE and network. The latter case may involve exchange of training parameter values and the alignment on the training dataset between UE and network. The CSI encoder at the UE 116 may be finetuned, e.g., using transferred learning.

In one example, the UE 116 may have a trained CSI encoder model for one channel environment and retrain the model for different channel environment by finetuning the parameter values of the last output layer with the same or different output vector size from the previously trained CSI model while fixing the structure and parameter values for the rest of the layers.

In another example, the UE 116 may use the previously trained CSI encoder model for one channel environment as the initialization for performing model retraining for different channel environments. The support of listed training modes herein can be indicated by the UE 116 to the network 130.

In another embodiment, the UE 116 capability information includes an indication on the support of model switch, transfer, or reconfiguration. The model switch capability relates to the capability that the UE 116 can switch AI/ML model for CSI feedback among multiple models that the UE 116 supports. The model switching capability may also include the latency needed by the UE 116 to perform model switching. The model transfer capability relates to the capability that the UE 116 can operate the model that it received from the network 130 in a compiled format or through a model description. The model reconfiguration capability relates to the capability that the UE 116 can update the CSI encoder neural network parameters and/or structure from one setting to another setting. The structural neural network update may include increasing/decreasing the number of layers, updating connections between layers, changing the order of placing the layers, enabling/disabling feed forward skip connections, concatenations, e.g., to support residual neural network (ResNet) or dense neural network (DenseNet) operations, etc.

In another embodiment, the UE 116 capability information includes an indication on the supported neural network capabilities. For example, the capability information may include the supported neural network types such as Perceptron, Feed Forward, CNN (Convolutional Neural Network), RNN (Recurrent Neural Network), LSTM (Long Short-Term Memory), GAN (Generative Adversarial Networks), Attention layer, Transformer, etc.

As another example, the capability information may include a level of supported neural network complexities such as in terms of the number of layers, neurons, connections, parameters, FLOPs, or in terms of the size of the model, e.g., in kilobytes, megabytes, etc.

As another example, the capability information may include supported neural network activation functions such as logistic (sigmoid), hyperbolic (tanh), rectified linear unit (ReLU) functions, etc.

In another embodiment, the UE 116 capability information includes an indication on the supported quantization method for the AI/ML-based CSI encoder output such as vector, scalar, uniform, and/or non-uniform quantization.

The UE 116 is provided, from the network 130, an AI/ML model for CSI feedback, e.g., via model ID, model transfer, or model description including neural network structure, parameter values, and feedback format such as the CSI encoder output vector size, quantization method, and the number of bits for quantization.

In one embodiment, in order to assist the network 130 to configure a proper model for AWL-based CSI feedback, the UE 116 may provide assistance information to the network 130. As an example, assistance information can include UE perceived channel environment, e.g., UMa/UMi/InH/rural, clutter/blockage presence/density/severity, LOS/NLOS indication, indoor/outdoor indication, in-car indication, in-building indication, mobility in terms of velocity or categorization of speeds, e.g., pedestrian/vehicle/high-speed train, etc.

In one embodiment, if the UE 116 supports solely one AWL-based CSI feedback model with fixed or reconfigurable parameter values, the UE 116 is provided from the network 130 on the activation/deactivation of the AWL-based CSI feedback model using Boolean indication.

In another embodiment, if the UE 116 supports more than one AI/ML-based CSI feedback models with fixed or reconfigurable parameter values, the UE 116 is provided from the network 130 on the corresponding AWL-based CSI feedback model using model ID. In this case, the multiple models supported by the UE 116 can be registered to the network 130 during UE capability indication and assigned with unique IDs. Deactivation of AWL-based CSI feedback model can be indicated separately using Boolean indication or by indicating a certain reserved value in the model ID, e.g., null.

In another embodiment, a UE receives an AI/ML-based CSI feedback model transferred from the network 130 or according to the model description received from the network 130 including neural network structure, and/or parameter values. The transferred model or provided model description shall remain within the indicated UE capability.

In another embodiment, a UE can be provided by the network 130 the AI/ML-based CSI encoder output vector size, quantization method, and the quantization resolution, e.g., resulting total number of bits after quantization, quantization bits per element in the CSI encoder output vector, or the ratio of output vector size to the total resulting quantized number of bits. The network 130 can vary from high-resolution to low-resolution CSI feedback through different configurations of elements mentioned herein. The UE 116 may be provided by the network 130 one or multiple output layer configurations, i.e., the final layer in the AWL-based CSI encoder, including the output layer size, e.g., number of neurons, connections with the previous layer(s), and the relevant parameter values to generate different output vector sizes.

The UE 116 is provided, from the network 130, information related to AWL-based CSI feedback model monitoring, triggering events to send a report, and/or transmission of any assistance information to the network 130. The UE 116 sends to the network 130 the model monitoring report if triggering events are met and/or any assistance information.

In one embodiment, a UE is provided from the network 130 on the performance index to monitor the performance of the currently used AWL-based CSI feedback model and the triggering events to send the report to the network 130 when the conditions are met. The report can be also periodically triggered with the periodicity set by the network 130 or aperiodically triggered by the network 130 via L1/L2 or any higher layer signaling.

As an example, a UE can be signaled from the network 130 to monitor PDCCH and/or physical downlink shared channel (PDSCH) decoding error rate and send a report if the measured error rate is larger than or smaller than an indicated/predefined target value with an optionally indicated/predefined margin or if the measured error rate goes out of an indicated/predefined target value range with max/min values. The UE 116 can be configured with a window duration in time or in number of PDCCH and/or PDSCH receptions to average and measure the error rate. The error rate can be measured for the initial reception or for the final reception if hybrid automatic repeat request (HARD) is applied.

As another example, the UE 116 can be signaled from the network 130 to monitor the received signal-to-noise ratio (SNR) or spectral efficiency and send a report if the measured value is larger than or smaller than a target value with an optional margin or if the measured error rate goes out of a target value range with max/min values. The target value(s) can be predefined, indicated by the network 130 or set by the UE 116 itself based on the estimated effective SNR or spectral efficiency calculated when the UE 116 obtained the CSI. The UE 116 can be configured with a window duration in time or in number of measurements, e.g., CSI-RS measurements for target value calculation, PDCCH/PDSCH measurements for received SNR or spectral efficiency calculation.

In another embodiment, the UE 116 can be indicated by the network 130 to send certain assistant information to the network 130 such that the performance monitoring can be performed at the network 130. As an example, the UE 116 can be indicated by the network 130 to send both AWL-based CSI feedback and CSI feedback using typical method, e.g., Type-I/II feedback, such that the network 130 can measure the difference in the acquired CSI information from the two different methods. The transmission of both feedback by UE using AWL-based method and common method can be periodically triggered with the periodicity set by the network 130, aperiodically triggered by the network 130 via L1/L2, or any higher layer signaling. Alternatively, it can be event triggered according to the conditions set by the network 130 based on PDCCH/PDSCH error rate, received SNR, or spectral efficiency as described herein.

In another embodiment, the UE 116 may receive certain assistant information from the network 130 such that the performance monitoring can be performed at the UE 116. As an example, the network 130 reconstructs the CSI using AWL-based method and send it back to the UE 116, e.g., using typical Type-I/II feedback, in raw data, or using any signaling method, such that the UE 116 can compare the reconstructed CSI at the network 130 with its own CSI. The UE 116 can then measure similarity between its own CSI and the CSI reconstructed at the network 130 and send the feedback containing similarity measure, e.g., cosine similarity, squared cosine similarity, NMSE, etc., to the network 130.

In another embodiment, the network 130 can monitor the performance by itself, e.g., using HARQ acknowledgement (ACK) feedback from the UE 116. For instance, if the PDCCH/PDSCH decoding error rate at the UE 116 is greater or smaller than its target value used for modulation and coding scheme (MCS) determination with a certain margin, the network 130 can regard that the performance of AWL-based CSI feedback model is impacted and may contemplate to switch/update the model used by the UE 116 or to instruct the UE 116 to fallback to a default mode.

The UE 116 is provided, from the network 130, to perform AI/ML model switch, update, retraining, or fallback to a default feedback method for CSI feedback.

In one embodiment, a UE can be indicated from the network 130 the AWL-based CSI feedback model ID via layer 1 (L1)/layer 2 (L2) or higher-layer signaling to perform model switching. As an example, the switching can be part of RRC reconfiguration during handover if the UE 116 has multiple site-specifically trained models.

In another embodiment, a UE can be indicated from the network 130 via L1/L2 or higher-layer signaling to fallback to default CSI feedback method, e.g., Type-I/II feedback.

In another embodiment, a UE can be provided from the network 130 a new AI/ML-based CSI feedback model, e.g., via model transfer, or a new model description including neural network structure, parameter values such that the UE 116 may reconfigure neural network parameter values, or both neural network structure as well as parameter values.

In another embodiment, a UE can be instructed by the network 130 to perform model retraining or finetuning, e.g., via transferred learning as described herein. If separate training is performed, the UE 116 can be provided by the network 130 the reference CSI decoder ID to be assumed for training the CSI encoder at the UE 116, the dataset, or the dataset ID so that the UE 116 can download the dataset from an external server. If joint training is performed, the UE 116 is instructed by the network 130 to enter interactive training session in which forward propagation and backward propagation values are exchanged for a given dataset batch ID, which is indicated by the network 130.

In one embodiment, such exchanges of forward propagation and backward propagation values may occur through over-the-air signaling. The exchange of forward propagation and backward propagation values may be repeated over multiple dataset batches. The UE 116 can be also indicated by the network 130 the cost function to be used during training, e.g., (NSME, cosine similarity, squared cosine similarity, etc., or the cost function may be predefined for a given use case of CSI feedback. The UE 116 can be indicated by the network 130 whether the model retraining will be performed for the entire CSI encoder with maintaining the model structure but solely the parameter values, possibly updating the model structure as well parameter values, or solely the final output layer structure and/or parameter values.

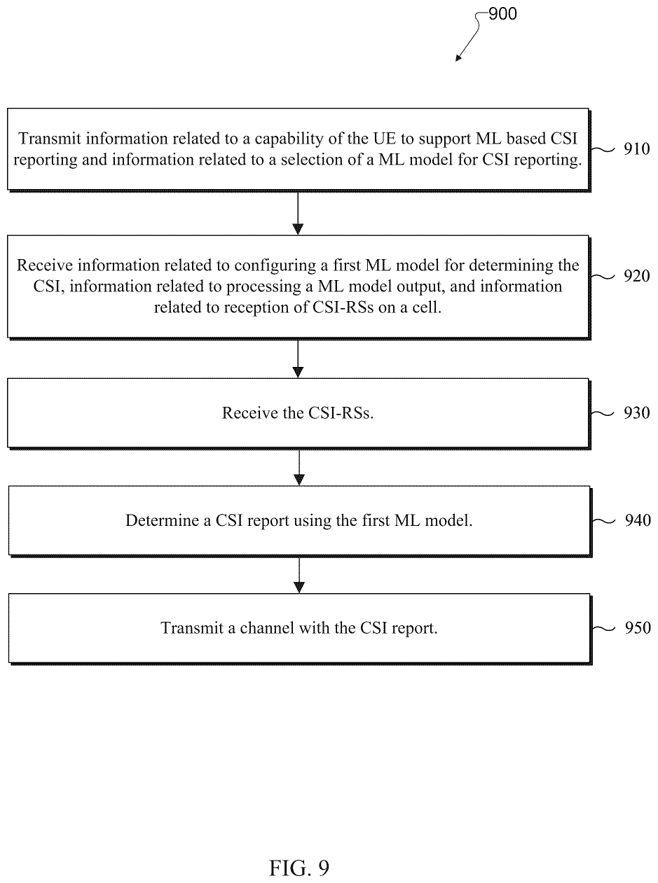

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method begins with the UE transmitting information related to a capability of the UE to support ML based CSI reporting and information related to a selection of a ML model for CSI reporting (910). In various embodiments, the information related to a capability of the UE to support ML based CSI reporting indicates at least one of (i) information related to a first number of supported ML models trained for a number of cell-specific, site-specific, or scenario-specific dataset, (ii) information related to a supported ML model complexity, wherein the ML model complexity is indicated by at least one of a ML model size, a number of floating point operations (FLOP) per unit time, and parameters related to a configuration of a NN, (iii) information related to processing ML model output including a number of quantization methods for the ML model output including vector quantization, scalar uniform quantization, or scalar non-uniform quantization, (iv) information related to a number of supported ML model training methods, (v) an indication on a support of model switching from the first ML model to another ML model or a non-ML CSI reporting method, and (vi) indication on a support of model transfer in a compiled format or in a descriptive format. In various embodiments, the information related to a selection of a ML model for CSI reporting includes a UE velocity in an absolute value, in a range of values, or in a type of movement or a channel environment related to multi-path signal propagation delay, Doppler, or blockages.

The UE then receives information related to configuring a first ML model for determining the CSI, information related to processing a ML model output, and information related to reception of CSI-RS s on a cell (920). In various embodiments, the information related to configuring the first ML model indicates at least one of an index from a first number of supported ML models, a ML model in a compiled format, and a ML model in a descriptive format, wherein the descriptive format provides parameters related to one or more layers of a NN. In various embodiments, the information related to processing the ML model output indicates at least one of parameters related to a CSI payload size including a size of an output vector of the first ML model and parameters related to quantizing the output vector of the first ML model including a quantization method and quantization granularity. For example, the quantization method includes vector quantization, scalar uniform quantization, and scalar non-uniform quantization and the quantization granularity provides assignment of bits to each element of output vector.

The UE then receives the CSI-RS s (930). For example, in 930, the UE receives the CSI-RS based on the received information related to reception of CSI-RS s on the cell. The UE then determines a CSI report using the first ML model (940). For example, in 940, the UE determines the CSI report based on the information related to configuring a first ML model for determining the CSI, the information related to processing a ML model output, and the reception of the CSI-RS s. The UE then transmits a channel with the CSI report (950).

In various embodiments, the UE further receives information related to monitoring a performance of a ML model including one or more of a ground-truth CSI, a performance index, a monitoring periodicity, and a cost function for measuring the performance. For example, the ground-truth CSI is a channel matrix or a precoding matrix, the ground-truth CSI is provided using scalar quantization or codebook-based quantization, the performance index includes NMSE, metrics based on cosine similarity, including SGCS, throughput, BLER, and ACK/NACK, the monitoring periodicity is periodic, semi-persistent, or aperiodic, and the cost function is NMSE or based on cosine similarity including SGCS. The UE further receives information related to transmitting a performance monitoring report including a triggering condition and an uplink channel for the transmission of the CSI report. For example, the triggering condition includes periodic, semi-persistent, aperiodic reporting, and event-based reporting. The UE determines, based on the information related to monitoring a performance of a ML model, the performance monitoring report for the first ML model. The UE then transmits a channel with the performance monitoring report based on the information related to transmitting the performance monitoring report and receives an indication to retrain the first ML mode, or an indication to switch the first ML model to another ML model or non-ML CSI reporting method.

In various embodiments, the UE further receives information related to retraining the first ML model including one or more of a training type, a cost function for training, a paired ML model for training, information related to one or more datasets for training, and information related to one or more layers of NN for training. The UE then retrains, based on the information related to retraining the first ML model, the first ML model to a second ML model and determines a second CSI report using the second ML model.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to report channel state information (CSI), the method comprising:
transmitting:
first information related to a capability of the UE to support machine learning (ML) based CSI reporting, and
second information related to a selection of a ML model for CSI reporting;
receiving:
third information related to configuring a first ML model for determining the CSI,
fourth information related to processing a ML model output,
fifth information related to reception of CSI reference signals (CSI-RS s) on a cell, and
the CSI-RS s based on the fifth information;
determining, based on the third and fourth information and the reception of the CSI-RS s, a CSI report using the first ML model; and
transmitting a channel with the CSI report.

2. The method of claim 1, wherein the first information indicates at least one of:
information related to a first number of supported ML models trained for a number of cell-specific, site-specific, or scenario-specific dataset,
information related to a supported ML model complexity, wherein the ML model complexity is indicated by at least one of a ML model size, a number of floating point operations (FLOP) per unit time, and parameters related to a configuration of a neural network (NN),
information related to processing ML model output including a number of quantization methods for the ML model output including vector quantization, scalar uniform quantization, or scalar non-uniform quantization,
information related to a number of supported ML model training methods,
an indication on a support of model switching from the first ML model to another ML model or a non-ML CSI reporting method, and
indication on a support of model transfer in a compiled format or in a descriptive format.

3. The method of claim 1, wherein the second information includes:
a UE velocity in an absolute value, in a range of values, or in a type of movement, or
a channel environment related to multi-path signal propagation delay, Doppler, or blockages.

4. The method of claim 1, wherein the third information indicates at least one of:
an index from a first number of supported ML models,
a ML model in a compiled format, and
a ML model in a descriptive format, wherein the descriptive format provides parameters related to one or more layers of a neural network (NN).

5. The method of claim 1, wherein the fourth information indicates at least one of:
parameters related to a CSI payload size including a size of an output vector of the first ML model, and
parameters related to quantizing the output vector of the first ML model including a quantization method and quantization granularity, wherein:
the quantization method includes vector quantization, scalar uniform quantization, and scalar non-uniform quantization, and
the quantization granularity provides assignment of bits to each element of output vector.

6. The method of claim 1, further comprising:
receiving:
sixth information related to monitoring a performance of a ML model including one or more of a ground-truth CSI, a performance index, a monitoring periodicity, and a cost function for measuring the performance, wherein:
the ground-truth CSI is a channel matrix or a precoding matrix,
the ground-truth CSI is provided using scalar quantization or codebook-based quantization,
the performance index includes normalized mean square error (NMSE), metrics based on cosine similarity, including squared generalized cosine similarity (SGCS), throughput, block error rate (BLER), and acknowledgement (ACK)/negative acknowledgement (NACK),
the monitoring periodicity is periodic, semi-persistent, or aperiodic, and
the cost function is NMSE or based on cosine similarity including SGCS, and
seventh information related to transmitting a performance monitoring report including a triggering condition and an uplink channel for the transmission of the performance monitoring report, wherein the triggering condition includes periodic, semi-persistent, aperiodic reporting, and event-based reporting;
determining, based on the sixth information, the performance monitoring report for the first ML model;
transmitting a channel with the performance monitoring report based on the seventh information; and
receiving:
an indication to retrain the first ML model, or
an indication to switch the first ML model to another ML model or non-ML CSI reporting method.

7. The method of claim 1, further comprising:
receiving eighth information related to retraining the first ML model including one or more of:
a training type,
a cost function for training,
a paired ML model for training,
information related to one or more datasets for training, and
information related to one or more layers of a neural network (NN) for training;
retraining, based on the eighth information, the first ML model to a second ML model; and
determining a second CSI report using the second ML model.

8. A base station comprising:
a transceiver configured to:
receive first information related to a capability of a user equipment (UE) to support machine learning (ML) based channel state information (CSI) reporting;
receive second information related to a selection of a ML model for CSI reporting;
transmit third information related to configuring a first ML model for determining the CSI;
transmit fourth information related to processing a ML model output;
transmit fifth information related to transmission of CSI reference signals (CSI-RSs) on a cell;
transmit the CSI-RSs based on the fifth information; and
receive a channel with a CSI report based on the first ML model and the CSI-RSs.

9. The base station of claim 8, wherein the first information indicates at least one of:
information related to a first number of supported ML models trained for a number of cell-specific, site-specific, or scenario-specific dataset,
information related to a supported ML model complexity, wherein the ML model complexity is indicated by at least one of a ML model size, a number of floating point operations (FLOP) per unit time, and parameters related to a configuration of a neural network (NN),
information related to processing ML model output including a number of quantization methods for the ML model output including vector quantization, scalar uniform quantization, or scalar non-uniform quantization,
information related to a number of supported ML model training methods,
an indication on a support of model switching from the first ML model to another ML model or a non-ML CSI reporting method, and
indication on a support of model transfer in a compiled format or in a descriptive format.

10. The base station of claim 8, wherein the second information includes:
a UE velocity in an absolute value, in a range of values, or in a type of movement, or
a channel environment related to multi-path signal propagation delay, Doppler, or blockages.

11. The base station of claim 8, wherein the third information indicates at least one of:
an index from a first number of supported ML models,
a ML model in a compiled format, and
a ML model in a descriptive format, wherein the descriptive format provides parameters related to one or more layers of a neural network (NN).

12. The base station of claim 8, wherein the fourth information indicates at least one of:
parameters related to a CSI payload size including a size of an output vector of the first ML model, and
parameters related to quantizing the output vector of the first ML model including a quantization method and quantization granularity, wherein:
the quantization method includes vector quantization, scalar uniform quantization, and scalar non-uniform quantization, and
the quantization granularity provides assignment of bits to each element of output vector.

13. The base station of claim 8, wherein:
the transceiver is further configured to:
transmit sixth information related to monitoring a performance of a ML model including one or more of a ground-truth CSI, a performance index, a monitoring periodicity, and a cost function for measuring the performance, wherein:
the ground-truth CSI is a channel matrix or a precoding matrix,
the ground-truth CSI is provided using scalar quantization or codebook-based quantization,
the performance index includes normalized mean square error (NMSE), metrics based on cosine similarity, including squared generalized cosine similarity (SGCS), throughput, block error rate (BLER), and acknowledgement (ACK)/negative acknowledgement (NACK),
the monitoring periodicity is periodic, semi-persistent, or aperiodic, and
the cost function is NMSE or based on cosine similarity including SGCS, and
transmit seventh information related to transmitting a performance monitoring report including a triggering condition and an uplink channel for the transmission of the performance monitoring report, wherein the triggering condition includes periodic, semi-persistent, aperiodic reporting, and event-based reporting;
receive a channel with the performance monitoring report for the first ML model based on the seventh information; and
transmit:
an indication to retrain the first ML model, or
an indication to switch the first ML model to another ML model or non-ML CSI reporting method.

14. The base station of claim 8, wherein the transceiver is further configured to:
transmit receiving eighth information related to retraining the first ML model including one or more of:
a training type,
a cost function for training,
a paired ML model for training,
information related to one or more datasets for training, and
information related to one or more layers of a neural network (NN) for training; and
receive a second CSI report using a second ML model retrained from the first ML model based on the eighth information.

15. A user equipment (UE) comprising:
a transceiver configured to:
transmit first information related to a capability of the UE to support machine learning (ML) based channel state information (CSI) reporting;
transmit second information related to a selection of a ML model for CSI reporting;
receive third information related to configuring a first ML model for determining the CSI;
receive fourth information related to processing a ML model output;
receive fifth information related to reception of CSI reference signals (CSI-RS s) on a cell; and
receive the CSI-RS s based on the fifth information;
a processor operably coupled to the transceiver, the processor configured to determine, based on the third and fourth information and the reception of the CSI-RSs, a CSI report using the first ML model,
wherein the transceiver is further configured to transmit a channel with the CSI report.

16. The UE of claim 15, wherein the first information indicates at least one of:
information related to a first number of supported ML models trained for a number of cell-specific, site-specific, or scenario-specific dataset,
information related to a supported ML model complexity, wherein the ML model complexity is indicated by at least one of a ML model size, a number of floating point operations (FLOP) per unit time, and parameters related to a configuration of a neural network (NN),
information related to processing ML model output including a number of quantization methods for the ML model output including vector quantization, scalar uniform quantization, or scalar non-uniform quantization,
information related to a number of supported ML model training methods,
an indication on a support of model switching from the first ML model to another ML model or a non-ML CSI reporting method, and
indication on a support of model transfer in a compiled format or in a descriptive format.

17. The UE of claim 15, wherein the second information includes:
a UE velocity in an absolute value, in a range of values, or in a type of movement, or
a channel environment related to multi-path signal propagation delay, Doppler, or blockages.

18. The UE of claim 15, wherein the third information indicates at least one of:
an index from a first number of supported ML models,
a ML model in a compiled format, and
a ML model in a descriptive format, wherein the descriptive format provides parameters related to one or more layers of a neural network (NN).

19. The UE of claim 15, wherein the fourth information indicates at least one of:
parameters related to a CSI payload size including a size of an output vector of the first ML model, and
parameters related to quantizing the output vector of the first ML model including a quantization method and quantization granularity, wherein:
the quantization method includes vector quantization, scalar uniform quantization, and scalar non-uniform quantization, and
the quantization granularity provides assignment of bits to each element of output vector.

20. The UE of claim 15, wherein:
the transceiver is further configured to receive:
sixth information related to monitoring a performance of a ML model including one or more of a ground-truth CSI, a performance index, a monitoring periodicity, and a cost function for measuring the performance, wherein:
the ground-truth CSI is a channel matrix or a precoding matrix,
the ground-truth CSI is provided using scalar quantization or codebook-based quantization,
the performance index includes normalized mean square error (NMSE), metrics based on cosine similarity, including squared generalized cosine similarity (SGCS), throughput, block error rate (BLER), and acknowledgement (ACK)/negative acknowledgement (NACK),
the monitoring periodicity is periodic, semi-persistent, or aperiodic, and
the cost function is NMSE or based on cosine similarity including SGCS, and
seventh information related to transmitting a performance monitoring report including a triggering condition and an uplink channel for the transmission of the performance monitoring report, wherein the triggering condition includes periodic, semi-persistent, aperiodic reporting, and event-based reporting;
the processor is further configured to determine, based on the sixth information, the performance monitoring report for the first ML model; and
the transceiver is further configured to:
transmit a channel with the performance monitoring report based on the seventh information; and
receive:
an indication to retrain the first ML model, or
an indication to switch the first ML model to another ML model or non-ML CSI reporting method.
